(19) United States
(12) Patent Application Publication
(10) Pub. No.: US 2008/0213156 A1
(43) Pub. Date: Sep. 4, 2008

(54) Method For The Manufacture Of A Reactor To Separate Gases

(75) Inventors: Armin Muller, Freiberg (DE); Torsten Still, Freiberg (DE)

Correspondence Address: MCGLEW & TUTTLE, PC, P.O. BOX 9227, SCARBOROUGH STATION, SCARBOROUGH, NY, 10510-9227, US

(73) Assignee: JOINT SOLAR SILICON GMBH & Co. KG, Freiberg (DE)

(21) Appl. No.: 11/573,425

(22) PCT Filed: Jul. 26, 2005
(86) PCT No.: PCT/EP05/08101

§ 371 Date: Feb. 8, 2007

(30) Foreign Application Priority Data
Aug. 10, 2004 (DE) 10 2004 038 717.6

(51) Int. Cl. C01B 33/02; B01J 19/00; B05D 7/22

(52) U.S. Cl. 423/349; 422/129; 427/181; 427/183

(57) ABSTRACT

Method for manufacturing a reactor for separating a gas containing silicon, comprising the following stages: preparation of a substantially tubular reactor blank with an inner wall and an outer wall, and application of a separating layer containing a powdery separating medium, at least onto the inner wall of the reactor blank. The reactor with the separating layer applied thereon offers simple and effective protection of the inner wall from deposited silicon powder. The separating layer and the silicon powder deposited thereon can easily be removed mechanically, without the inner wall being damaged.

### BACKGROUND OF THE INVENTION

1. Field of the Invention

The invention relates to a method for manufacturing a reactor for separating a gas containing silicon. The invention also relates to a reactor manufactured by the method according to the invention. Furthermore, the invention relates to the use of the reactor according to the invention for manufacturing silicon that is suitable as a raw material for manufacturing silicon melts for the production of silicon blocks or silicon crystals.

2. Background Art

Methods for manufacturing high-purity silicon have been known for a long time. Prime poly silicon resulting from these methods has a high level of purity, due to its slow thermal deposition, and only low surface impurities that are transferred to the melt, due to its very large ratio of volume/surface. The disadvantage of these methods is that they have a very high specific energy consumption per kilogramme of pure silicon and high production costs, due to the slow deposition rate.

An energy- and cost-saving manufacturing method for pure silicon is known from DE 10 2004 027 563.7, in which a monosilane-hydrogen mixture is thermally separated and silicon powder is produced, which is then mechanically compressed. Silicon produced in this way is easily processed and has no silicon oxide compounds on the surface of the silicon particles, so that the melting temperature of the silicon powder produced lies in the region of the melting temperature of silicon. The disadvantage of this method of manufacture is that the silicon deposited from the gas phase, also called Chemical Vapour Deposition (CVD), settles as a layer on the walls of the heated reactor. This reactor normally consists of glass, particularly vitreous silica, which has a different thermal expansion coefficient compared to silicon. When the reaction vessel cools down, there are large forces and tensions between the deposited silicon layer and the vitreous silica as a result of the different thermal expansion coefficients. This leads to damage to the reactor, in particular cracks and chips, which pass into the resulting silicon powder and contaminate it.

### SUMMARY OF THE INVENTION

The object of the invention is to provide a method for manufacturing a reactor that protects the reactor effectively and simply from damage from deposited silicon layers.

This object is achieved a method for manufacturing a reactor for separating a gas containing silicon, comprising the following stages: provision of a substantially tubular reactor blank with an inner wall and an outer wall, and application of a separating layer containing a powdery separating medium, at least onto the inner wall of the reactor blank. The object is also achieved by a reactor for separating a gas containing silicon, manufactured in accordance with the aforementioned method. The object is also achieved by the use of a reactor for manufacturing silicon that is suitable as a raw material for manufacturing silicon melts for the production of silicon blocks or silicon crystals, comprising the following stages: provision of a reactor produced in accordance with the above aforementioned method, supply of a gas containing silicon into the reactor, thermal separation of the gas with the formation of silicon, deposition of at least part of the resulting silicon as a silicon layer on the separating layer, and removal of the separating layer and the silicon deposited thereon. The core of the invention is to apply a separating layer to the inner wall of the reactor blank, before the thermal separation of a gas containing silicon, which protects the inner wall from the silicon layer that is produced and deposited. The separating layer is preferably applied such that silicon powder is dispersed in a volatile liquid with low surface tension, for example acetone, and this dispersion is then introduced into the reactor and distributed evenly over the inner wall of the reactor by rotation. A separating layer of dried silicon powder, which can easily be removed from the inner wall, forms through slow evaporation of the volatile liquid. The silicon layer produced as a result of the thermal separation settles on the separating layer and no longer forces its way as far as the inner wall of the reactor, as a result of the separating layer. The silicon layer produced can therefore no longer attach itself to the inner wall of the reactor. The separating layer with the silicon layer deposited thereon can easily be removed mechanically or chemically, without damage occurring to the inner wall of the reactor.

Additional characteristics, details and advantages of the invention will emerge from the following description of a preferred embodiment with reference to the drawing.

### BRIEF DESCRIPTION OF THE DRAWING

FIG. 1 shows a section of equipment for manufacturing silicon with a reactor according to the invention.

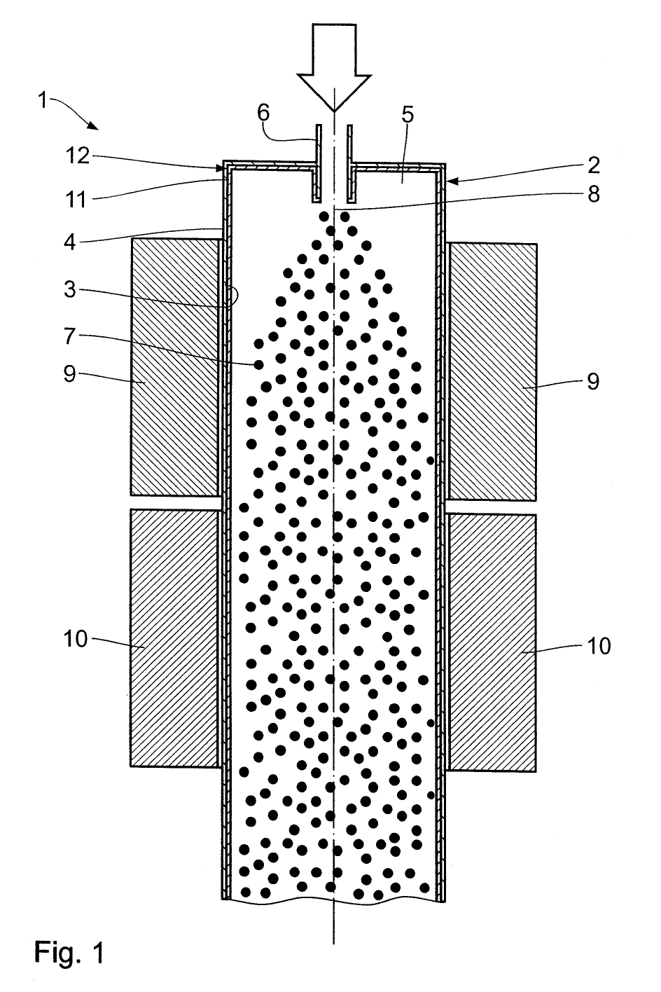

### DESCRIPTION OF THE PREFERRED EMBODIMENT

The construction of equipment 1 for manufacturing silicon powder is described first hereinafter. The equipment 1 has a vertical tubular reactor blank 2 with an inner wall 3 and an outer wall 4, which encloses a cylindrical reaction chamber 5. A gas supply pipe 6 is arranged at the upper end of the reactor blank 2 and feeds into the reactor chamber 5. A gas 7 containing silicon, for example monosilane, can be fed in through the gas supply pipe 6. The reactor blank 2 has a central longitudinal axis 8, about which it can be rotatably driven. The upper half of the reactor blank 2 is surrounded by a cylindrical ring heating device 9, which encloses the reactor blank 2 such that the walls 3, 4 of the reaction chamber 5 can be heated to temperatures of more than 800° C. The lower half of the reactor blank 2 is surrounded by a cylindrical ring cooling device 10, which directly abuts the heating device 9. If required, the equipment 1 can comprise other units for processing the silicon powder that is formed, which are connected to the cooling device 10.

The surface of the inner wall 3 of the reactor blank 2 is coated with a separating layer 11. The reactor blank 2 with the separating layer 11 applied is described as reactor 12 in the present invention.

The corresponding reactor blank 2 must be first prepared for the manufacture of the coated reactor 12. It preferably consists of glass, vitreous silica, graphite, CFC or SiC. Next, the reaction chamber 5 of the reactor blank 2 is filled with a powdery separating medium and applied to the inner wall 3 of the reactor blank 2 as a separating layer 11. The powdery separating medium 11 is preferably dispersed in a dispersant before application. An easily evaporating liquid with an evaporation temperature of ≦800° C., in particular ≦400° C. and particularly advantageously ≦100° C. at normal ambient pressure can be used as the dispersant. Dispersants containing a solvent, especially acetone, have been proven in practice. Acetone has an evaporation temperature of 56° C. at normal ambient pressure.

The separating medium preferably consists at least partially of the same material of the material expected to be deposited. A powder of a silicon compound, especially silicon powder, has been proven in practice as a separating medium. The powder particles of the separating medium have an average diameter of 0.01 μm to 100 μm, preferably 0.02 μm to 20 μm and more preferably 0.1 μm to 10 μm.

The reactor blank 2, the reaction chamber 5 of which has been filled with the volatile liquid with dispersed silicon powder, is set into rotation about its central longitudinal axis 8, to apply the separating layer 11. The slurry of silicon powder and the volatile liquid is distributed evenly on the inner wall 3 of the rotating reactor blank 2 as a result of the centrifugal force. The separating layer 11 forms through the slow evaporation of the volatile liquid, which layer 11 dries on the inner wall 3 of the reactor blank 2. The separating layer 11 has a thickness of 10 μm to 5000 μm, preferably 20 μm to 500 μm and more preferably 30 μm to 200 μm. It is also possible to remove the reactor blank 2 from the equipment 1 to apply the separating layer 11 and to set it turning in a horizontal position, so that the slurry is distributed evenly on the inner wall 3. The application of the separating layer 11 can also take place through electrostatic coating or by spraying on a dispersant.

The reactor blank 2, with the separating layer 11 applied, is used in the equipment 1 as a reactor 12 for manufacturing silicon, which is suitable as a raw material for manufacturing silicon melt for the production of polycrystalline silicon blocks or silicon crystals. Reference is made to DE 10 2004 027 563.7 for a detailed description of the manufacture of silicon powder from a gas containing silicon, for example monosilane or trichlorosilane. The gas 7 containing silicon, which is fed into the reactor 12, is thermally separated with the formation of silicon powder. A layer of silicon at least partially settles on the surface of the separating layer 11 using CVD.

The reactor 12 must be cleaned after a certain period of use and the separating layer 11, with the silicon layer deposited thereon, removed. This preferably takes place mechanically, since the separating layer 11 is attached to the inner wall 3 relatively loosely, whereas the deposited silicon layer is attached relatively firmly to the separating layer 11. When the separating layer 11 is mechanically removed, the silicon powder thereon is likewise removed, without the inner wall 3 of the reactor 12 being damaged. Chemical removal is also possible, e.g. by using lyes. After cleaning the reactor 12, a new separating layer 11 can be applied to the remaining reactor blank 2 and it can be used again for manufacturing silicon powder. To increase the intervals between cleaning the reactor 12, the gas 7 containing silicon can additionally be surrounded by an auxiliary gas, for example hydrogen, in the form of a ring current, so that the deposition rate of the silicon layer that forms on the separating layer 11 is reduced. The use of an auxiliary gas in the form of a ring current is likewise described in detail in DE 10 2004 027 563.7.

1. Method for manufacturing a reactor for separating a gas containing silicon, comprising the following stages:
a. provision of a substantially tubular reactor blank with an inner wall and an outer wall, and
b. application of a separating layer containing a powdery separating medium, at least onto the inner wall of the reactor blank.

2. Method according to claim 1, wherein the separating medium is dispersed in a dispersant before being applied.

3. Method according to claim 1, wherein the reactor blank has a central longitudinal axis and can be rotatably driven about the central longitudinal axis to apply the separating layer.

4. Method according to claim 1, wherein the separating medium consists at least partially of silicon, particularly silicon powder.

5. Method according to claim 2, wherein the dispersant is a liquid with an evaporation temperature of ≦800° C. at normal ambient pressure.

6. Method according to claim 5, wherein the dispersant contains acetone.

7. Method according to claim 1, wherein the separating layer has a thickness of 10 μm to 5000 μm.

8. Method according to claim 7, wherein the powder particles of the separating medium have an average diameter of 0.01 μm to 100 μm.

9. Reactor for separating a gas containing silicon, manufactured in accordance with the method according to claim 1.

10. Use of a reactor for manufacturing silicon that is suitable as a raw material for manufacturing silicon melts for the production of silicon blocks or silicon crystals, comprising the following stages:
a. provision of a reactor produced in accordance with the method according to claim 1,
b. supply of a gas containing silicon into the reactor,
C. thermal separation of the gas with the formation of silicon,
d. deposition of at least part of the resulting silicon as a silicon layer on the separating layer, and
e. removal of the separating layer and the silicon deposited thereon.

11. Method according to claim 2, wherein the dispersant is a liquid with an evaporation temperature of ≦400° C. at normal ambient pressure.

12. Method according to claim 2, wherein the dispersant is a liquid with an evaporation temperature of ≦100° C. at normal ambient pressure.

13. Method according to claim 1, wherein the separating layer has a thickness of 20 μm to 500 μm.

14. Method according to claim 1, wherein the separating layer has a thickness of 30 μm to 200 μm.

15. Method according to claim 7, wherein the powder particles of the separating medium have an average diameter of 0.02 μm to 20 μm.

16. Method according to claim 7, wherein the powder particles of the separating medium have an average diameter of 0.1 μm to 10 μm.
